(19) United States
(12) Patent Application Publication
(10) Pub. No.: US 2023/0408729 A1
(43) Pub. Date: Dec. 21, 2023

(54) Meta-Optics Element And Manufacture Method Thereof

(71) Applicant: National Central University, Taoyuan City (TW)

(72) Inventors: Chih-Ming Wang, Taoyuan City (TW); Wei-Lun Hsu, Taoyuan City (TW); Yu-Hsuan Liao, Taoyuan City (TW)

(21) Appl. No.: 17/887,038

(22) Filed: Aug. 12, 2022

(30) Foreign Application Priority Data
Jun. 20, 2022 (TW) 111122923

(51) Int. Cl. G02B 1/11

(52) U.S. Cl. CPC G02B 1/11

(57) ABSTRACT

The present invention discloses a meta-optics element comprising a substrate, a meta-optics structure and an anti-reflection structure. The meta-optics structure comprises multiple meta-optics units geometrically disposed on the substrate. The anti-reflection structure comprises multiple anti-reflection units corresponding to these meta-optics units and disposed on the surface of the corresponding meta-optics units. Besides, a manufacture method of meta-optics element is also disclosed.

This application claims the benefit of Taiwan Patent Application Serial No. 111122923, filed Jun. 20, 2022, the subject matter of which is incorporated herein by reference.

### BACKGROUND OF INVENTION

### 1. Field of the Invention

The present invention relates to an optical element. More particularly, the present invention relates to a meta-optics element.

### 2. Description of the Prior Art

A meta-optics element is an artificial structure with dimensions in the sub-wavelength. The meta-optics element has special optical properties that are not found in natural substances, and can exhibit different optical responses with different geometric shapes, sizes and materials.

FIG. 1 is a schematic diagram of prior art meta-optics element, wherein the left half (A) illustrates the entire meta-optics element, and the right half (B) illustrates a partial magnification of the meta-optics element. Please refer to FIG. 1, the prior art meta-optics element 100 comprises a substrate 110, an anti-reflection layer 120 and a meta-optics structure 130, wherein the anti-reflection layer 120 is disposed on the substrate 110, and the meta-optics structure 130 is disposed on the anti-reflection layer 120. The meta-optics structure 130 comprises multiple meta-optics units 132, and these meta-optics units 132 are arranged on the anti-reflection layer 120 at specific geometric positions to have special optical properties.

The anti-reflection layer 120 is used to reduce the effect of light reflection to improve the overall optical transmittance of the meta-optics element 100. However, recent studies have shown that no matter how the thickness and material of the anti-reflection layer 120 are adjusted, the efficiency of optical penetration cannot be significantly improved.

### SUMMARY OF THE INVENTION

In view of this, the present invention provides a meta-optics element comprising a substrate, a meta-optics structure and an anti-reflection structure. The meta-optics structure comprises multiple meta-optics units disposed on the substrate in a geometric manner. The anti-reflection structure comprises multiple anti-reflection units corresponding to the meta-optics units and disposed on the surface of the corresponding meta-optics units.

According to one embodiment of the present invention, the anti-reflection units can be disposed on the top surface or the side surface of the corresponding meta-optics units, or disposed between the corresponding meta-optics units and the substrate.

According to one embodiment of the present invention, the meta-optics units and the anti-reflection units can be in sub-wavelength dimensions. The shape of the anti-reflection units may be cone.

The present invention also provides a manufacture method of a meta-optics element, comprising: providing a substrate; forming an optical composite layer on the substrate and defining an optical pattern; and forming a meta-optics structure and an anti-reflection structure via etching the optical composite layer with the optical pattern, wherein the meta-optics structure comprises multiple meta-optics units, and the anti-reflection structure comprises multiple anti-reflection units corresponding to the meta-optics units.

According to one embodiment of the present invention, the step of forming the optical composite layer may comprise: forming an optics layer on the substrate; and forming an anti-reflection layer on the optics layer. In another embodiment of the present invention, the step of forming the optical composite layer may comprise: forming a first anti-reflection layer on the substrate; forming an optics layer on the first anti-reflection layer; and forming a second anti-reflection layer on the optics layer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a schematic diagram of a prior art meta-optics element.

FIG. 2 is a schematic diagram of meta-optics element according to an embodiment of the present invention.

FIG. 3 is a schematic diagram of meta-optics element according to another embodiment of the present invention.

FIG. 4 is an experimental data graph of optical transmittance of meta-optics element of the present invention and the prior art.

FIG. 5 is a schematic diagram of manufacture method of meta-optics element according to an embodiment of the present invention.

FIG. 6 is a schematic diagram of manufacture method of meta-optics element according to another embodiment of the present invention.

FIG. 7 is a schematic diagram of meta-optics units and anti-reflection units in different aspects according to yet another embodiment of the present invention.

### DESCRIPTION OF THE PREFERRED EMBODIMENT

FIG. 2 is a schematic diagram of meta-optics element according to an embodiment of the present invention, wherein the upper left part (A) illustrates the entire meta-optics element, the upper right part (B) and the lower left part (C) both illustrate a partial magnification of the meta-optics element, and the lower right part (D) illustrates a single meta-optics unit and a single anti-reflection unit corresponding to the single meta-optics unit. Please refer to FIG. 2, the meta-optics element 200 of the present invention comprises a substrate 210, a meta-optics structure 220 and an anti-reflection structure 230. The meta-optics structure 220 comprises multiple meta-optics units 222, and these meta-optics units 222 are disposed on the substrate 210 in a specific geometric manner. The anti-reflection structure 230 comprises multiple anti-reflection units 232, and these anti-reflection units 232 correspond to these meta-optics units 222 and are disposed on the surface of the corresponding meta-optics units 222.

The meta-optics units 222 and the anti-reflection units 232 are, for example, in sub-wavelength dimensions, and each meta-optics unit 222 or each anti-reflection unit 232 may have different sizes according to different configurations of geometric positions. In this embodiment, the shapes of the meta-optics units 222 and the anti-reflection units 232 are, for example, rectangular parallelepipeds, but the present invention does not limit the shapes of the meta-optics units 222 and the anti-reflection units 232. In addition, the anti-reflection units 232 are, for example, disposed on the top surface of the corresponding meta-optics units 222, but the present invention does not limit the relative disposition relationship between the anti-reflection units 232 and the meta-optics units 222, which will be described with another embodiment below.

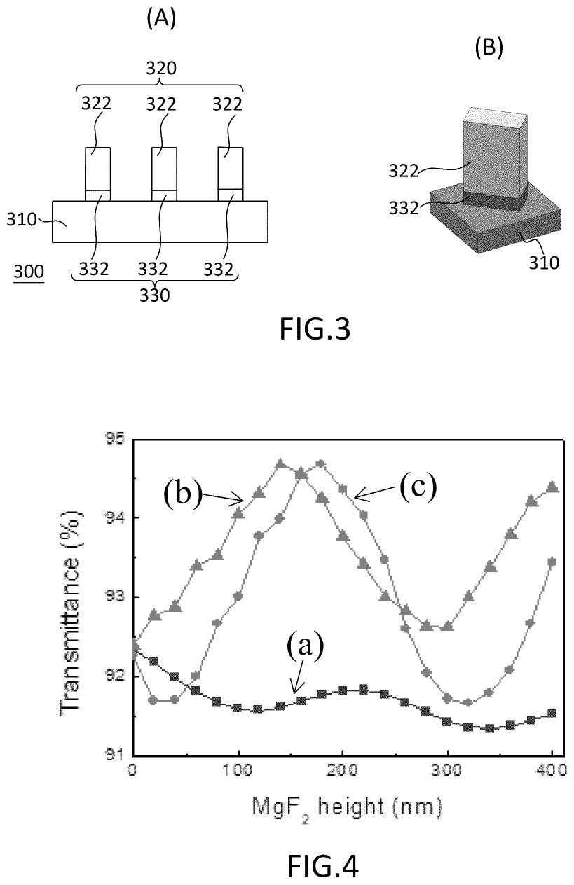

FIG. 3 is a schematic diagram of meta-optics element according to another embodiment of the present invention, wherein the left half (A) illustrates a partial magnification of the meta-optics element, and the right half (B) illustrates a single meta-optics unit and a single anti-reflection unit corresponding to the meta-optics unit. Please refer to FIG. 3, the meta-optics element 300 of this embodiment is similar to the meta-optics element 200 of FIG. 2, the meta-optics structure 320 and the anti-reflection structure 330 of the meta-optics element 300 also have similar geometrical configurations, and the difference is that the anti-reflection units 332 are disposed between the corresponding meta-optics units 322 and substrate 310 in this embodiment. In other words, the anti-reflection units 232 in FIG. 2 are disposed on the top surface of the meta-optics units 222, and the anti-reflection units 332 in FIG. 3 are disposed on the bottom surface of the meta-optics units 322.

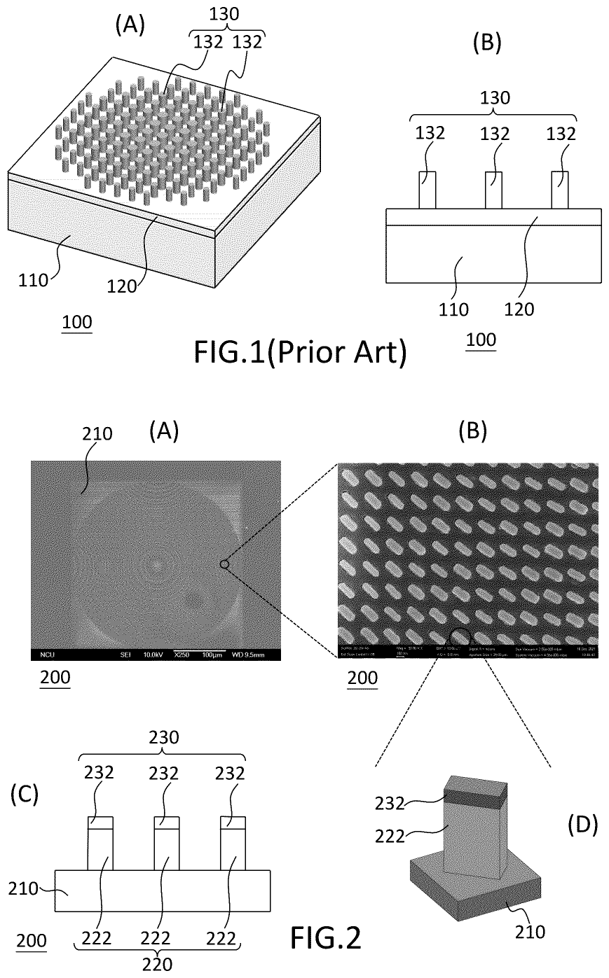

FIG. 4 is an experimental data graph of optical transmittance of meta-optics element of the present invention and the prior art, wherein the horizontal axis represents the height of the anti-reflection layer/anti-reflection units made of Magnesium Fluoride (MgF₂), and the vertical axis represents the optical transmittance of the meta-optics element. Please refer to FIG. 1 to FIG. 4 at the same time, curve a, curve b, and curve c in FIG. 4 correspond to the experimental results of the meta-optics element 100 of FIG. 1, the meta-optics element 200 of FIG. 2 and the meta-optics element 300 of FIG. 3 respectively. Compared with the prior art meta-optics element 100, the meta-optics elements 200, 300 of the present invention both have higher optical transmittance.

Specifically, compared with the prior art anti-reflection layer 120 having a flat structure, when the light source passes through multiple independent anti-reflection units 232, 332 of the present invention, the wavefront has a larger radius of curvature to have more concentrated vertical forward wave lines. The concentrated vertical forward wave lines further reduce the occurrence of reflection and improve the optical transmittance.

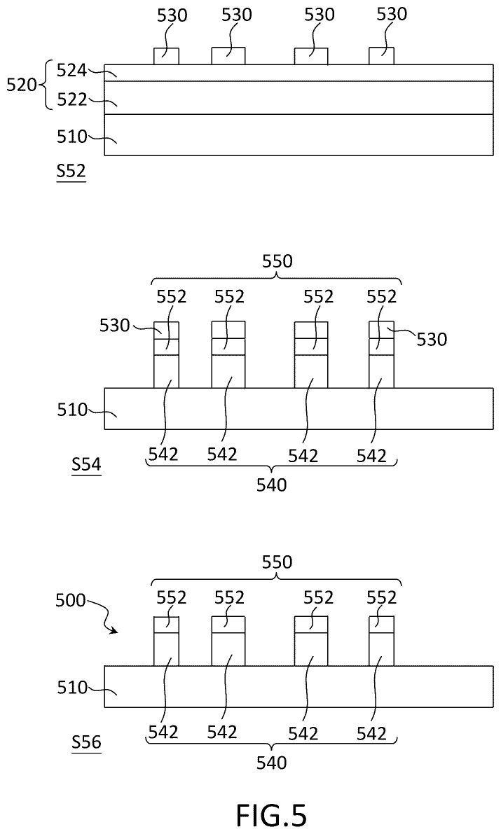

FIG. 5 is a schematic diagram of manufacture method of meta-optics element according to an embodiment of the present invention. Please refer to FIG. 5, as shown in step S52, a substrate 510 is first provided, and then an optical composite layer 520 is formed on the substrate 510, and an optical pattern 530 is defined on the optical composite layer 520. In this embodiment, the optical composite layer 520 is composed of, for example, the optics layer 522 and the anti-reflection layer 524, that is, the optics layer 522 is formed on the substrate 510 first, and then the anti-reflection layer 524 is formed on the optics layer 522. In addition, the optical pattern 530 is formed by, for example, photoresist exposure and development.

Next, as shown in step S54, the optical composite layer 520 is etched with the optical pattern 530 to form a meta-optics structure 540 and an anti-reflection structure 550, wherein the meta-optics structure 540 comprises multiple meta-optics units 542, and the anti-reflection structure 550 comprises multiple anti-reflection units 552 corresponding to the meta-optics units 542.

Next, as shown in step S56, the optical pattern 530 is removed to complete the fabrication of the meta-optics element 500, wherein the overall structure of the meta-optics element 500 is similar to the meta-optics element 200 in FIG. 2. It is worth noting that by adjusting the structure of the optical composite layer, meta-optics elements with different structures can be obtained, and another embodiment will be given below and explained with drawings.

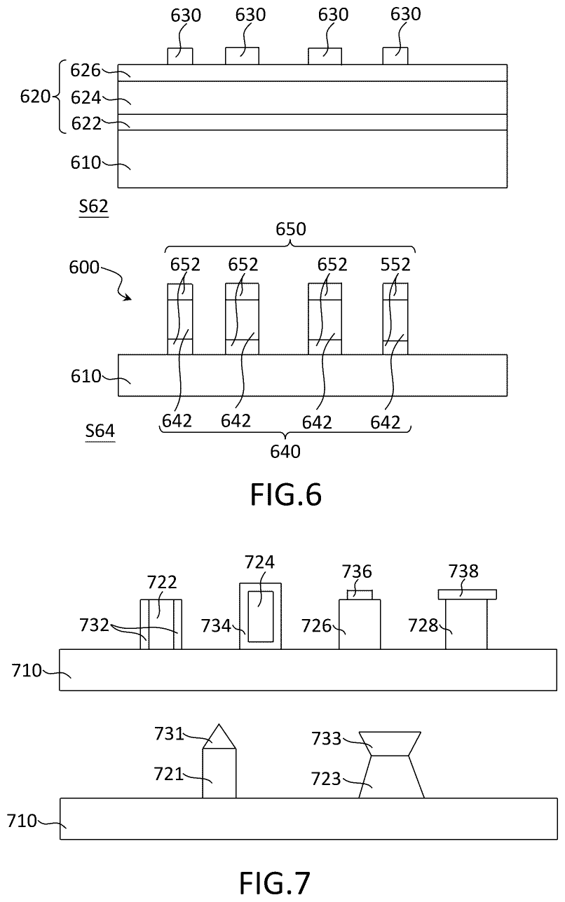

FIG. 6 a schematic diagram of manufacture method of meta-optics element according to another embodiment of the present invention. Please refer to FIG. 5 and FIG. 6 at the same time, the manufacture method of FIG. 6 is similar to the manufacture method of FIG. 5, and the difference is that the optical composite layer 620 with different structure is formed in step S62. Specifically, the optical composite layer 620 is composed of, for example, the first anti-reflection layer 622, the optics layer 624 and the second anti-reflection layer 626, that is, the first anti-reflection layer 622, the optics layer 624 and the second anti-reflection layer 626 are sequentially formed on the substrate 610.

After defining the optical pattern 630 on the optical composite layer 620, the optical composite layer 620 can be etched with the optical pattern 630 to form the meta-optics element 600 after etching and removing the optical pattern 630, as shown in step S64. A meta-optics structure 640 and an anti-reflection structure 650 are formed in the process of etching the optical composite layer 620, wherein the meta-optics structure 640 comprises multiple meta-optics units 642, and the anti-reflection structure 650 comprises multiple anti-reflection units 652 corresponding to these meta-optics units 642.

It is worth noting that although the present embodiment uses a traditional etching process to form the meta-optics elements 500, 600, the present invention does not limit the manufacture method of the meta-optics element. For example, lift-off process, mass transfer process or other suitable process can also be used. In addition, the present invention does not limit the corresponding relationship between the meta-optics units and the anti-reflection units, and another embodiment will be given below for description with the accompanying drawings.

FIG. 7 is a schematic diagram of meta-optics units and anti-reflection units in different aspects according to yet another embodiment of the present invention. Please refer to FIG. 7, on the substrate 710, the anti-reflection unit 732 may be disposed on the side surfaces of the meta-optics unit 722. In another aspect, the anti-reflection unit 734 may be simultaneously disposed on the top, bottom and side surfaces of the meta-optics unit 724 to completely cover the meta-optics unit 724. In another aspect, the anti-reflection unit 736 may be disposed on the top surface of the meta-optics unit 726, but only partially cover the top surface of the meta-optics unit 726. In another aspect, the anti-reflection unit 738 may be disposed on the top surface of the meta-optics unit 728, and the coverage area of the anti-reflection unit 738 is larger than the top surface of the meta-optics unit 728.

Besides, the present invention does not limit the shapes of anti-reflection units and meta-optics units, such as cylinder, pyramid, cube, cone, 3D trapezoid, ladder, cuboid, rectangular parallelepiped or other suitable shape. For example, the shape of the anti-reflection unit 731 may be cone, which is disposed on the top surface of the meta-optics unit 721 having cylinder shape. In another aspect, the shape of the meta-optics units 723 is, for example, a 3D trapezoid with a wide bottom and a narrow top. On the contrary, the shape of the anti-reflection unit 731 is, for example, a 3D trapezoid with a wide top and a narrow bottom. Regardless of cost, these shaped anti-reflection units and meta-optics units can be fabricated using nanoscale 3D printing technology.

Incidentally, the individual meta-optics units of the meta-optics structure may have different sizes and shapes, and similarly, the individual anti-reflection units of the anti-reflection structure may also have different sizes and shapes. Through different combination designs, the meta-optics element of the present invention can simultaneously have optical properties that meet specific requirements and high optical transmittance.

Although the present invention has been described with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A meta-optics element comprising:
a substrate;
a meta-optics structure comprising multiple meta-optics units disposed on the substrate in a geometric manner; and
an anti-reflection structure comprising multiple anti-reflection units corresponding to the meta-optics units and disposed on the surface of the corresponding meta-optics units.

2. The meta-optics element of claim 1, wherein the anti-reflection units are disposed on the top surface of the corresponding meta-optics units.

3. The meta-optics element of claim 1, wherein the anti-reflection units are disposed between the corresponding meta-optics units and the substrate.

4. The meta-optics element of claim 1, wherein the anti-reflection units are disposed on the side surface of the corresponding meta-optics units.

5. The meta-optics element of claim 1, wherein the meta-optics units and the anti-reflection units are in sub-wavelength dimensions.

6. The meta-optics element of claim 1, wherein the shape of the anti-reflection units is cone.

7. A manufacture method of a meta-optics element, comprising:
providing a substrate;
forming an optical composite layer on the substrate and defining an optical pattern; and
forming a meta-optics structure and an anti-reflection structure via etching the optical composite layer with the optical pattern, wherein the meta-optics structure comprises multiple meta-optics units, and the anti-reflection structure comprises multiple anti-reflection units corresponding to the meta-optics units.

8. The manufacture method of the meta-optics element of claim 7, wherein the step of forming the optical composite layer comprises:
forming an optics layer on the substrate; and
forming an anti-reflection layer on the optics layer.

9. The manufacture method of the meta-optics element of claim 7, wherein the step of forming the optical composite layer comprises:
forming a first anti-reflection layer on the substrate; and
forming an optics layer on the first anti-reflection layer.

10. The manufacture method of the meta-optics element of claim 9, wherein the step of forming the optical composite layer further comprises: forming a second anti-reflection layer on the optics layer.
